(19) United States
(12) Patent Application Publication
(10) Pub. No.: US 2015/0190813 A1
(43) Pub. Date: Jul. 9, 2015

(54) HORIZONTAL SHAFT IMPACT CRUSHER FEED CHUTE

(71) Applicant: SANDVIK INTELLECTUAL PROPERTY AB, Sandviken (SE)

(72) Inventors: Rowan Dallimore, Bath (GB); Andreas Forsberg, Malmo (SE); Knut Kjaerran, Svedala (SE)

(21) Appl. No.: 14/410,050

(22) PCT Filed: May 27, 2013
(86) PCT No.: PCT/EP2013/060821

§ 371 Date: Dec. 19, 2014

(30) Foreign Application Priority Data
Jun. 20, 2012 (EP) 12172803.4

(51) Int. Cl. B02C 13/286; B02C 13/09

(52) U.S. Cl. CPC B02C 13/286; B02C 13/09; B02C 2013/28672

(57) ABSTRACT

A horizontal shaft impact crusher feed chute is arranged to receive material to be crushed and for forwarding the material to a crushing chamber of a horizontal shaft impact crusher. The chute includes a first opening arranged for receiving material to be crushed in a first crushing setting, and a second opening arranged for receiving material to be crushed in a second crushing setting.

### TECHNICAL FIELD OF THE INVENTION

The present invention relates to a horizontal shaft impact crusher feed chute adapted for receiving material to be crushed and for forwarding the material to a crushing chamber of a horizontal shaft impact crusher.

The present invention further relates to a method of feeding material to be crushed to a horizontal shaft impact crusher.

### BACKGROUND ART

Horizontal shaft impact crushers (HSI-crushers) are utilized in many applications for crushing hard material, such as pieces of rock, ore etc. A HSI-crusher has an impeller that is made to rotate around a horizontal axis. Pieces of rock are fed towards the impeller and are struck by beater elements mounted on the impeller. The pieces of rock are disintegrated by being struck by the beater elements, and are accelerated and thrown against breaker plates, often referred to as curtains, against which further disintegration occurs. The action of the impeller thus causes the material fed to the horizontal shaft impact crusher to move freely in a crushing chamber and to be crushed upon impact against the beater elements, against the curtains, and against other pieces of material moving around at high speed in the crushing chamber.

U.S. Pat. No. 6,189,820 discloses a HSI-crusher which is provided with a kit of feed plates of different designs. The purpose of the different feed plates is to adapt the crusher to various operating conditions. However, with the design described in U.S. Pat. No. 6,189,820 adapting the crusher for various materials is cumbersome, and the acceptable variation in the material to be crushed is still quite limited.

### SUMMARY OF THE INVENTION

It is an object of the present invention to provide for easy adaptation of a horizontal shaft impact crusher to crushing material of a wide range of sizes.

This object is achieved by means of a horizontal shaft impact crusher feed chute adapted for receiving material to be crushed and for forwarding the material to a crushing chamber of a horizontal shaft impact crusher, wherein the horizontal shaft impact crusher feed chute comprises a first opening adapted for receiving material to be crushed in a first crushing setting, and a second opening adapted for receiving material to be crushed in a second crushing setting.

An advantage of this horizontal shaft impact crusher feed chute is that it provides for simple and efficient adaptation of a horizontal shaft impact crusher to crushing various types of material. Hence, the horizontal shaft impact crusher feed chute makes it simple and efficient to rearrange one and the same crusher from a first crushing setting to a second crushing setting, or the other way around, using one and the same feed chute.

According to one embodiment the feed chute comprises a first cover mounting device for mounting a first cover over the first opening in the second crushing setting. An advantage of this embodiment is that the risk of material inadvertently bouncing out of the first opening when crushing in the second crushing setting, and feeding material through the second opening, is reduced.

According to one embodiment the feed chute comprises a second cover mounting device for mounting a second cover over the second opening in the first crushing setting. An advantage of this embodiment is that the risk of material inadvertently bouncing out of the second opening when crushing in the first crushing setting, and feeding material through the first opening, is reduced.

According to one embodiment the second opening is an essentially horizontal opening. An advantage of this embodiment is that feeding the material through a horizontal opening, and in a vertical downward direction, is often beneficial for crushing in the second crushing setting, in particular if the second crushing setting is a secondary crushing setting.

According to one embodiment the first opening is an essentially vertical opening. An advantage of this embodiment is that feeding the material through a vertical opening, and in an at least partially horizontal direction through the feed chute and into the crushing chamber, is often beneficial for crushing in the first crushing setting, in particular if the first crushing setting is a primary crushing setting.

According to one embodiment the feed chute comprises parallel side walls connecting the first opening to a crusher mounting device, which is arranged for mounting the feed chute to a housing of a horizontal shaft impact crusher, wherein the side walls have an essentially triangular shape as seen from the side thereof. An advantage of the triangular side walls is that the feed chute may also form a transitional piece, forming a transition between a crusher housing with an inclined mouth to vertical and/or horizontal openings of the feed chute.

According to one embodiment the first opening is separated from the second opening. An advantage of this embodiment is that the feed chute will be more distinctly adaptable for operation of the crusher in first or second crushing setting, as the case may be.

According to one embodiment the feed chute comprises at least one crushing chamber shield adapted to prevent material from being thrown out of the crushing chamber and out of the feed chute. An advantage of this embodiment is that material may be fed to the feed chute via, for example, the first opening, with a limited risk that the material is inadvertently thrown out of that same opening, or vice versa when the material is fed to the second opening.

According to one embodiment the crushing chamber shield is adapted to be located in a first position on the feed chute in a first crushing setting, and in a second position on the feed chute in a second crushing setting. An advantage of this embodiment is that fewer parts are needed, since the same crushing chamber shield can be utilized in both the first and the second crushing setting.

According to one embodiment the feed chute comprises a floor portion adapted for collecting a bed of material protecting the lower portions of the feed chute from wear. An advantage of this embodiment is that the life of the feed chute may be increased.

According to one embodiment the feed chute comprises at least one hatch adapted to at least partly cover the first opening in a first mounting position, and to at least partly cover the second opening in a second mounting position. An advantage of this embodiment is that fewer parts are needed, since the same hatch can be utilized in both the first and the second crushing setting.

A further object of the present invention is to provide a more efficient method of operating a horizontal shaft impact crusher.

This object is achieved by means of a method of feeding material to be crushed to a horizontal shaft impact crusher, the method comprising feeding, when the crusher operates in a first crushing setting, the material through a first opening of a horizontal shaft impact crusher feed chute and further into a crushing chamber of the horizontal shaft impact crusher for being crushed, and feeding, when the crusher operates in a second crushing setting, the material through a second opening of the horizontal shaft impact crusher feed chute and further into the crushing chamber of the horizontal shaft impact crusher for being crushed.

An advantage of this method is that crushing of material can be made more efficient, since shifting between a first crushing setting, for example primary crushing setting, to a second crushing setting, for example secondary crushing setting, can be made very quickly, such that the downtime during which no material is crushed can be minimized.

According to one embodiment the method comprises forwarding the material in an essentially vertical direction into the second opening of the feed chute when the crusher operates in the second crushing setting. An advantage of this embodiment is that some types of crushing procedures, such as crushing in a secondary crushing setting, become more efficient when feeding the material to be crushed in an essentially vertical direction.

According to one embodiment the method comprises forwarding the material in an at least partly horizontal direction into the first opening of the feed chute when the crusher operates in the first crushing setting. An advantage of this embodiment is that some types of crushing procedures, such as crushing in a primary crushing setting, become more efficient when feeding the material to be crushed in an at least partly horizontal direction.

According to one embodiment the method further comprises reducing the opportunities for material to leave the crushing chamber via the first opening of the feed chute when the crusher operates in the second crushing setting, and/or reducing the opportunities for material to leave the crushing chamber via the second opening of the feed chute when the crusher operates in the first crushing setting. An advantage of this embodiment is that material will not, or at least not to any significant degree, inadvertently leave the feed chute via one opening that is inactive in the present crushing setting.

According to one embodiment the method further comprises reducing the opportunities for material to rebound out of the crushing chamber via the first opening of the feed chute when the crusher operates in the first crushing setting, and/or reducing the opportunities for material to rebound out of the crushing chamber via the second opening of the feed chute when the crusher operates in the second crushing setting. An advantage of this embodiment is that material is at least partly prevented from leaving the feed chute via one opening that is active in the present crushing setting.

Further objects and features of the present invention will be apparent from the description and the claims.

### BRIEF DESCRIPTION OF THE DRAWINGS

The invention will hereafter be described in more detail and with reference to the appended drawings.

FIG. 1 is a cross-sectional side view of a horizontal shaft impact crusher.

FIG. 2a is a three-dimensional view and illustrates a horizontal shaft impact crusher feed chute, when in a primary crushing setting.

FIG. 2b is a front view of the horizontal shaft impact crusher feed chute of FIG. 2a, when in the primary crushing setting.

FIG. 2c is a cross-sectional view, and illustrates the horizontal shaft impact crusher feed chute of FIG. 2a, in the primary crushing setting.

FIG. 3a is a three-dimensional view and illustrates the horizontal shaft impact crusher feed chute, when in a secondary crushing setting.

FIG. 3b is a front view of the horizontal shaft impact crusher feed chute of FIG. 3a, when in the secondary crushing setting.

FIG. 3c is a cross-sectional view, and illustrates the horizontal shaft impact crusher feed chute of FIG. 3a, in the secondary crushing setting.

### DETAILED DESCRIPTION OF PREFERRED EMBODIMENTS OF THE INVENTION

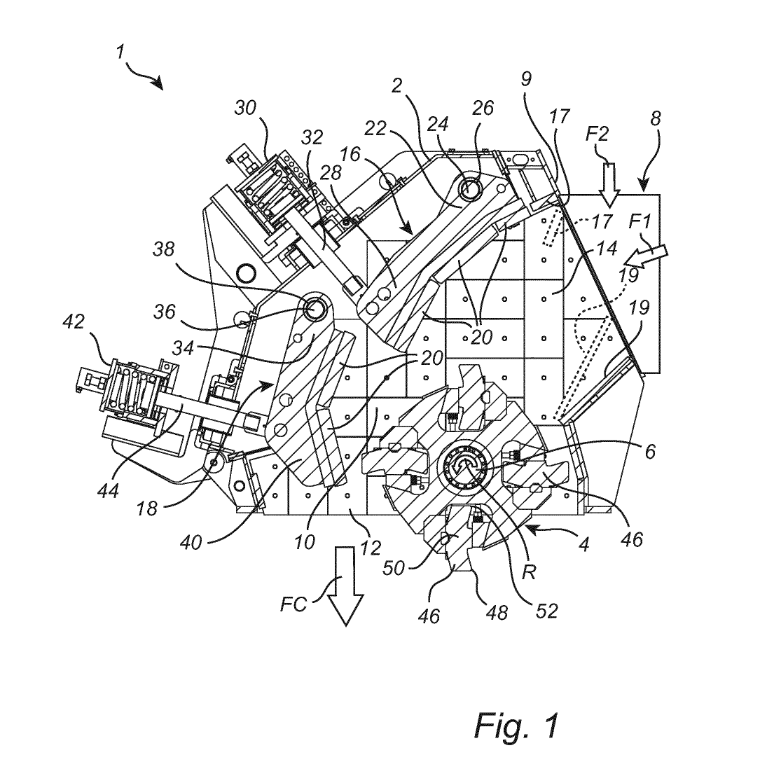

FIG. 1 is a cross-section and illustrates, schematically, a horizontal shaft impact crusher 1 (HSI-crusher). The horizontal shaft impact crusher 1 comprises a housing 2 in which an impeller 4 is arranged. A motor, not illustrated for reasons of maintaining clarity of illustration, is operative for rotating a horizontal shaft 6 on which the impeller 4 is mounted. As alternative to the impeller 4 being fixed to the shaft 6, the impeller 4 may rotate around the shaft 6. In either case, the impeller 4 is operative for rotating around a horizontal axis, coinciding with the centre of the horizontal shaft 6.

Material to be crushed is fed to a horizontal shaft impact crusher feed chute 8, which is mounted to an inlet flange 9 of the housing 2, and enters a crushing chamber 10 which is arranged inside the housing 2 and at least partly encloses the impeller 4. Material that has been crushed leaves the crushing chamber 10 via an outlet 12 for crushed material.

The housing 2 is provided with a plurality of interior wear protection plates 14 that are operative for protecting the interior of the crushing chamber 10 from abrasion and from impact by the material to be crushed.

The crusher 1 comprises a first curtain 16, and a second curtain 18 arranged inside the crushing chamber 10. Each curtain 16, 18 comprises at least one wear plate 20 against which material may be crushed.

A first end 22 of the first curtain 16 has been mounted by means of a horizontal first pivot shaft 24 extending through an opening 26 formed in the curtain 16 at the first end 22. The first pivot shaft 24 extends further through openings in the housing 2 to suspend the first end 22 in the housing 2. A second end 28 of the first curtain 16 is connected to a first adjustment device 30 comprising at least one adjustment bar 32.

A first end 34 of the second curtain 18 has been mounted by means of a horizontal second pivot shaft 36 extending through an opening 38 formed in the curtain 18 at the first end 34. The second pivot shaft 36 extends further through openings in the housing 2 to suspend the first end 34 in the housing 2. A second end 40 of the second curtain 18 is connected to a second adjustment device 42 comprising at least one adjustment bar 44.

The impeller 4 is provided with, for example, four beater elements 46, each such beater element 46 having, for example, a “banana” shape, as seen in cross-section. An arrow R indicates the direction of rotation of the impeller 4. A leading edge 48 of the respective beater element 46 extends in the direction of the direction of rotation R. The beater element 46 is symmetric around its central portion 50, such that once the leading edge 48 has been worn out the beater element 46 can be turned and mounted with its second leading edge 52 operative for crushing material.

The HSI-crusher 1 can be adjusted to a first crushing setting, which for example may be a primary crushing setting, for crushing large objects, typically objects having a maximum particle size of 300-1200 mm, and a second crushing setting, which is different from the first crushing setting and which may be a secondary crushing setting, for crushing intermediate size objects, having a maximum particle size of less than 400 mm, typically a maximum particle size of 20-400 mm. When the crusher 1 operates in the primary crushing setting the crushed material leaving the crusher 1 via the outlet 12 would typically have an average particle size of 35-300 mm, and typically at least 75% by weight of the crushed material would have a particle size of 20 mm or larger, and when the crusher 1 operates in the secondary crushing setting the crushed material leaving the crusher 1 via the outlet 12 would typically have an average particle size of 5 to 100 mm, and typically at least 75% by weight of the crushed material would have a particle size of 5 mm or larger. In this disclosure, “average particle size” refers to weight based average particle size.

For some sizes of material the crusher 1 could be set to either primary or secondary crushing setting. For example, when crushing a material having a maximum particle size of 350 mm, and the desired size of the crushed material is about 75 mm, then the crusher 1 would be set to a primary crushing setting, and when crushing that same material, of a maximum particle size 350 mm, and the desired size of the crushed material is about 25 mm, then the crusher 1 would be set to a secondary crushing setting. When crushing material having a maximum particle size of 500 mm or more, the crusher 1 would be arranged in the primary crushing setting, and when crushing material having a maximum particle size of 200 mm or less, the crusher 1 would be arranged in the secondary crushing setting.

Adjusting the crusher 1 to the primary crushing setting would typically involve retracting the first and/or second curtains 16, 18 away from the impeller 4, to form a crushing chamber 10 having a large volume and a large distance between the impeller 4 and the wear plates 20 of the curtains 16, 18. Such retraction of at least one curtain 16, 18 would be performed by operating the first and/or second adjustment devices 30, 42, which may, for example, as is per se known, involve hydraulic cylinders and/or mechanical adjustment devices involving threaded bars. Adjusting the crusher 1 to the secondary crushing setting would, on the other hand, typically involve moving the first and/or second curtains 16, 18 towards the impeller 4 by means of operating the first and/or second adjustment devices 30, 42, to form a crushing chamber 10 having a small volume and a short distance between the impeller 4 and the wear plates 20 of the curtains 16, 18. In addition to adjusting the position of the curtains 16, 18 also the horizontal shaft impact crusher feed chute 8 is adjusted, as will be described hereinafter in more detail, to feed the material into the crushing chamber 10 in a first direction F1 when the crusher 1 is adjusted to the primary setting, and in a second direction F2 when the crusher 1 is adjusted to the secondary setting. Hence, the first crushing setting is different from the second crushing setting. Furthermore, the first direction F1 of feeding material to the crusher 1 is different from the second direction F2 of feeding material to the crusher 1.

Optionally, the adjustment of the position of the curtains 16, 18 could involve adjusting the position of one or both of the pivot shafts 24, 36 to bring the respective first ends 22, 34 closer to, or further away from, the impeller 4.

Optionally, the adjustment of the HSI-crusher 1 from a primary crushing setting to a secondary crushing setting could, in addition to adjusting the position of the curtains 16, 18 and adjusting the feed chute 8, also involve adjusting the positions of an upper feed plate 17 and a lower feed plate 19 that are located just inside of the inlet flange 9 of the housing 2 of the crusher 1. The feed plates 17, 19 protect the inlet of the housing 2, and provide the material fed to the housing 2 with a desired direction. In the illustration of FIG. 1 the upper and lower feed plates 17, 19 are adjusted to a primary crushing setting, shown in unbroken lines, with the intention of directing the coarse material fed to the crusher 1, when the crusher 1 operates in the primary crushing setting, towards both the first curtain 16 and the impeller 4. The positions of the upper and lower feed plates 17, 19 in a secondary crushing setting are indicated with broken lines in FIG. 1. As can be seen the upper and lower feed plates 17, 19 are, in the secondary crushing setting, arranged for directing the material directly towards the impeller 4. In this manner, the rather fine material fed when the crusher 1 operates in the secondary crushing setting will receive more “hits” from the beater elements 46 of the impeller 4, leading to a greater reduction in the size of the material. The upper and lower feed plates 17, 19 may, hence, be adjustable for providing the feed material with a first direction towards the impeller 4 in the primary crushing setting, and for providing the feed material with a second direction, being different from the first direction, towards the impeller 4 in the secondary crushing setting.

In operation material to be crushed is fed to the horizontal shaft impact crusher feed chute 8 and further into the crushing chamber 10, either in the direction F1 if the crusher 1 is adjusted to the primary crushing setting, or in the direction F2 if the crusher 1 is adjusted to the secondary crushing setting. The material will first reach that part of the crushing chamber 10 which is located adjacent to the first curtain 16, being located upstream of the second curtain 18 as seen with respect to the direction of travel of the material. The impeller 4 rotates at, typically, 400-850 rpm. When the material is hit by the beater elements 46 of the impeller 4 it will be crushed and accelerated against the wear plates 20 of the first curtain 16 where further crushing occurs. The material will bounce back from the first curtain 16 and will be crushed further against material travelling in the opposite direction and, again, against the beater elements 46. When the material has been crushed to a sufficiently small size it will move further down the crushing chamber 10, and will be accelerated, by means of the beater elements 46, towards the wear plates 20 of the second curtain 18, being located downstream of the first curtain 16. Hence, the material will move freely around in the crushing chamber 10, and will be crushed against the beater elements 46, against the wear plates 20 of the curtains 16, 18, and against other pieces of material circling around, at a high velocity, in the crushing chamber 10. When the material has been crushed to a sufficiently small size it will leave the crushing chamber 10 via the outlet 12 as a flow of crushed material FC.

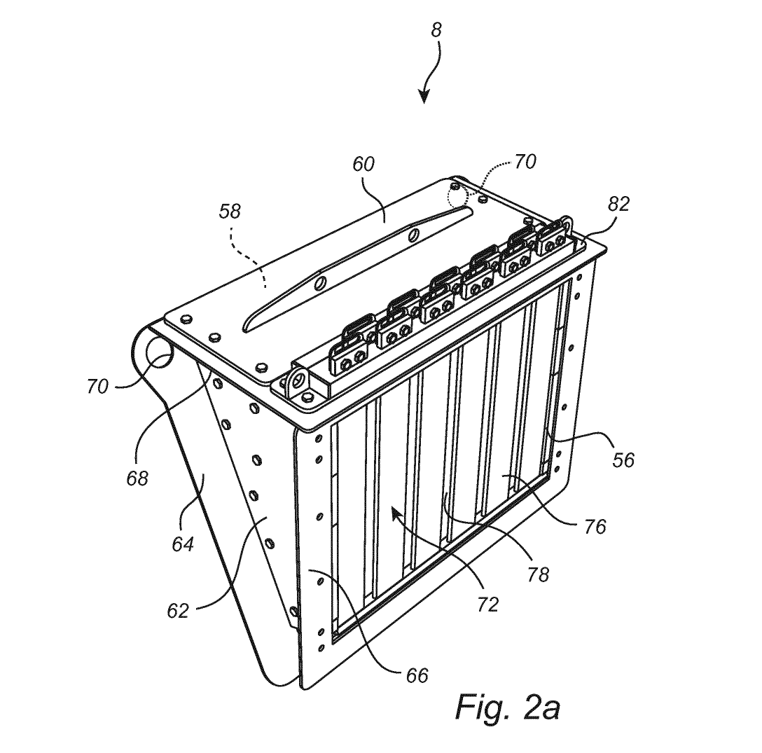

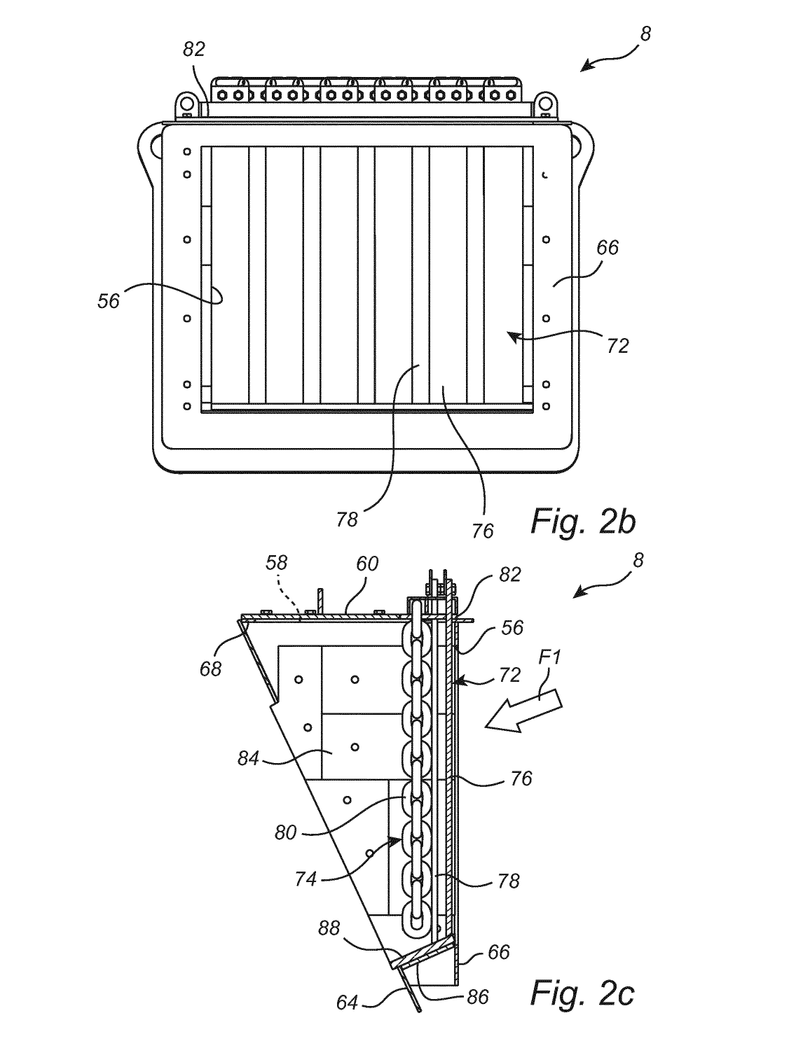

FIGS. 2a-c illustrate the horizontal shaft impact crusher feed chute 8 when in the primary crushing setting. The feed chute 8 comprises a vertical first opening 56 adapted for the primary crushing setting, and a horizontal second opening 58, which is different from the first opening 56 and is adapted for the secondary crushing setting. The first opening 56 is separated from the second opening 58. In the illustration of FIGS. 2a-c the feed chute 8 is in the primary crushing setting and a first cover (not shown in FIGS. 2a-c) has been removed from the vertical first opening 56. A second cover in the form of a hatch 60 has been mounted over the horizontal second opening 58, such that material may not enter or leave via the second opening 58.

The arrow F1 illustrates, in FIG. 2c, the at least partly horizontal direction of feeding material to the feed chute 8 via the first opening 56 during operation in the primary crushing setting.

The feed chute 8 comprises two parallel side walls 62, of which only one side wall 62 is visible in FIG. 2a, which connects a crusher mounting device, having the form of a crusher mounting flange 64, to the first opening 56, a first cover mounting device, having the form of a first opening flange 66, the second opening 58, and a second cover mounting device, having the form of a second opening flange 68. The crusher mounting flange 64 is arranged for mounting the feed chute 8 to the inlet flange 9 of the housing 2 of the horizontal shaft crusher 1. The first opening flange 66 is arranged for mounting the first cover over the vertical first opening 56. The second opening flange 68 is arranged for mounting the second cover, i.e., the hatch 60 over the horizontal second opening 58. In the embodiment of FIGS. 2a-c, the side wall 62 has a generally triangular shape, with the base of the triangle located adjacent to the horizontal second opening 58, and the point of the triangle pointing downwards, as best shown in FIGS. 2a and 2c. The crusher mounting flange 64 is, hence, inclined relative to the first opening flange 66. As shown in FIG. 1, the housing 2 is, at the connection to the feed chute 8, also inclined, such that the vertical first opening 56 of the feed chute 8 will be vertical, and the horizontal second opening 58 will be horizontal when the feed chute 8 is mounted to the housing 2 via the crusher mounting flange 64. Returning to FIG. 2a, the crusher mounting flange 64 is provided with locating openings 70 adapted for co-operating with locating studs (not shown) on the housing 2 of the crusher 1 to make correct mounting of the feed chute 8 on the housing 2 easier.

The feed chute 8 is provided with a first crushing chamber shield 72, which is shown in FIGS. 2a-c, and a second crushing chamber shield 74, which is best shown in FIG. 2c. The crushing chamber shields 72, 74 are flexible, and are arranged for allowing material to enter the vertical first opening 56 of the feed chute 8 when material is fed to the crusher 1, and to prevent material moving around freely inside of the crushing chamber 10 from being thrown out of the crushing chamber 10 via the feed chute 8. The first crushing chamber shield 72 comprises a first row of vertical rubber strips 76 and a second row of vertical rubber strips 78, with the first and second rows of rubber strips 76, 78 being arranged in an overlapping manner. The second crushing chamber shield 74 comprises a number of vertical chains 80. Both the first and second rows of rubber strips 76, 78 and the chains 80 are suspended from a front roof portion 82 of the feed chute 8, the front roof portion 82 being located adjacent to the vertical first opening 56. The rubber strips of the first and second rows of rubber strips 76, 78 can be moved to the sides, such that material may enter between adjacent strips. In a similar manner material may enter between adjacent chains 80. In accordance with alternative embodiments, only one of the crushing chamber shields 72, 74 may be utilized, although the embodiment of FIGS. 2a-c with two crushing chamber shields 72, 74 is often preferable due to the high momentum of the pieces of material moving around in the crushing chamber 10 during primary crushing.

The side walls 62 of the feed chute 8 are covered, on their respective inner sides and as illustrated in FIG. 2c, with interior wear protection plates 84 that may be of a similar design as the interior wear protection plates 14 of the crushing chamber 10. Furthermore, a floor portion 86 of the feed chute 8 may be covered by a bottom plate 88 of wear resistant material.

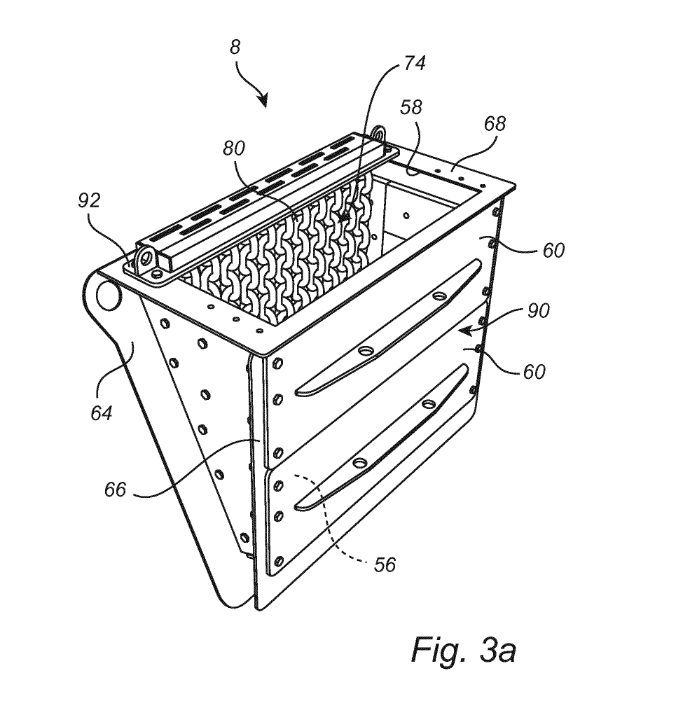

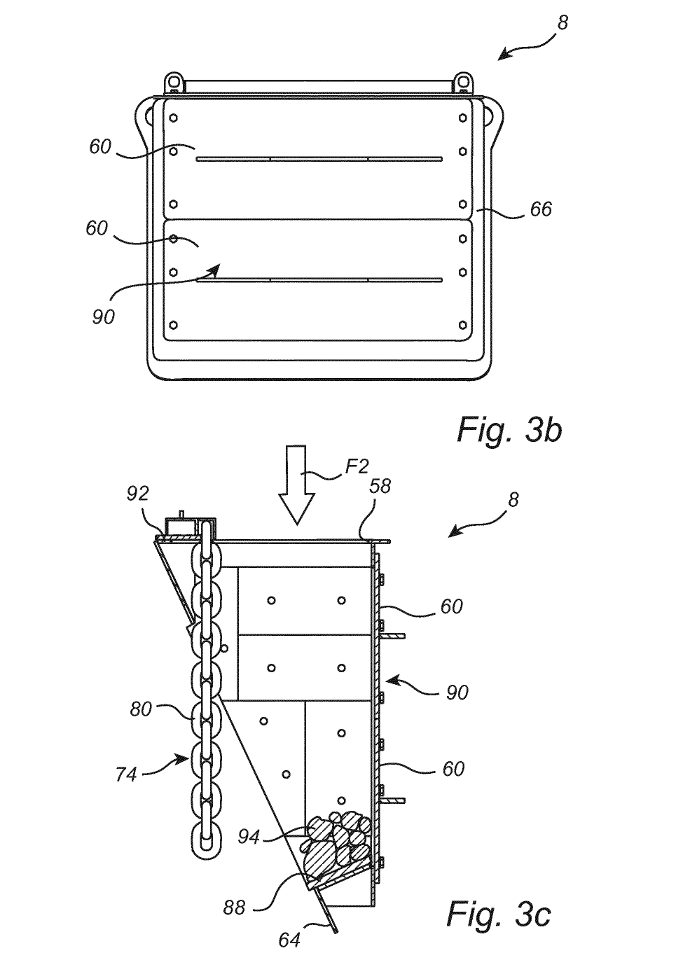

FIGS. 3a-c illustrate the horizontal shaft impact crusher feed chute 8 when in the secondary crushing setting. In the secondary crushing setting the second cover, i.e., the hatch 60, shown in FIG. 2a, has been removed from the horizontal second opening 58. The first cover 90 has been mounted to the first opening flange 66 to cover the vertical first opening 56, such that material may not enter or leave via the first opening 56. In accordance with one embodiment, the first cover 90 comprises, as best illustrated in FIGS. 3a and 3b, a first hatch 60 and a second hatch 60, each of which has the same design as the hatch 60 used as the second cover in the primary crushing setting illustrated in FIGS. 2a-c. Hence, one of the two hatches 60 forming the first cover 90 covering the first opening 56 in the secondary crushing setting could be used, in this embodiment, as the second cover covering the second opening 58 in the primary crushing setting. Thus, one hatch 60 is adapted to at least partly cover the first opening 56 in a first mounting position, in the secondary crushing setting, and to at least partly cover the second opening 58 in a second mounting position, in the primary crushing setting.

The arrow F2 illustrates, in FIG. 3c, the essentially vertical direction of feeding material to the feed chute 8 via the second opening 58 during operation in the secondary crushing setting.

In the secondary crushing setting the feed chute 8 is provided with only the second crushing chamber shield 74, comprising the vertical chains 80, for allowing material to enter the horizontal second opening 58 of the feed chute 8, and to prevent material moving around freely inside the crushing chamber 10 from being thrown out of the crushing chamber 10 via the feed chute 8. The chains 80 are suspended from a rear roof portion 92 of the feed chute 8, the rear roof portion 92 being different from the front roof portion 82 and being located adjacent to the crusher mounting flange 64. In accordance with an alternative embodiment, both the first and second crushing chamber shields 72, 74 may be utilized, although utilizing only the second crushing chamber shield 74 as illustrated in FIG. 3c is often sufficient to avoid pieces of material being thrown out of the feed chute 8 from the crushing chamber 10 when operating in the secondary crushing setting.

During operation of the crusher in the secondary crushing setting the bottom plate 88 of wear resistant material would typically become covered with a bed 94 of material, which would protect the bottom plate 88 and also other parts of the feed chute 8 from wear. The build up of the bed 94 of material may be promoted by the lower feed plate 19, illustrated in FIG. 1, since the lower feed plate 19 may form, together with the bottom plate 88 and the first cover 90, a “pocket” efficiently collecting material and forming the bed 94.

The horizontal shaft impact crusher feed chute 8 makes it very easy to shift between operation in a first crushing setting, such as primary crushing setting, and operation in a second crushing setting, such as secondary crushing setting.

When shifting from primary crushing setting, illustrated in FIGS. 2a-c, to secondary crushing setting, illustrated in FIGS. 3a-c, the hatch 60 is removed from the second opening 58, this hatch 60, plus another hatch 60, are mounted, as the first cover 90, over the first opening 56, the first crushing chamber shield 72 is removed, the second crushing chamber shield 74 is moved from the position at the front roof portion 82 to the position at the rear roof portion 92, and the feed chute 8 is ready for crushing in the secondary crushing setting.

When shifting from secondary crushing setting, illustrated in FIGS. 3a-c, to primary crushing setting, illustrated in FIGS. 2a-c, the hatches 60 forming the first cover 90 are removed from the first opening 56, one of these hatches 60 is mounted, as the second cover, over the second opening 58, the first crushing chamber shield 72 is installed at the front roof portion 82, the second crushing chamber shield 74 is moved from the position at the rear roof portion 92 to the position at the front roof portion 82, and the feed chute 8 is ready for crushing in the primary crushing setting.

Hence, shifting between primary and secondary crushing setting can be made by simply moving hatches 60 and shields 72, 74, without any need to replace or rebuild the feed chute 8 itself.

It will be appreciated that numerous modifications of the embodiments described above are possible within the scope of the appended claims.

Hereinbefore it has been described that the first cover 90 comprises two hatches 60, one of which being used also as the second cover. It will be appreciated that other types of hatches may be used, and that, for example, a single and specific hatch may be used as the first cover for covering the vertical first opening 56.

Hereinbefore it has been described, as illustrated in FIGS. 2a and 3a, that the first and second openings 56, 58 are completely separated from each other. It will be appreciated that it would also be possible to arrange the first and second openings 56, 58 in such a manner that a part of the first opening would also form a part of the second opening.

Hereinbefore it has been described that the crushing chamber shields 72, 74 comprises rubber strips and chains 80, respectively. It will be appreciated that other types of shields could be used, and in other combinations.

Hereinbefore it has been described that a second cover 60 is arranged over the horizontal second opening 58 when the HSI-crusher 1 is to operate in the primary crushing setting. In accordance with one embodiment, the horizontal second opening 58 could be left open during primary crushing, since the material would be fed via the first opening 56, arrow F1 in FIGS. 1 and 2c, and below the second opening 58. Optionally, a further crushing chamber shield, for example of the first or second shield type 72, 74, could be mounted to the rear roof portion 92 to reduce the risk that material is, during such primary crushing setting, thrown out of the second opening 58. Still further, in accordance with a yet further embodiment, the vertical first opening 56 could be left entirely or partly open during secondary crushing, in cases where a risk that some material supplied to the second opening 58 would inadvertently leave the feed chute 8 via the first opening 56 is acceptable.

Hereinbefore it has been described that the first crushing setting is a primary crushing setting, and that the second crushing setting is a secondary crushing setting. It will be appreciated that the first and second crushing settings may also be other types of crushing settings. For example, the first crushing setting could be a first type of primary crushing setting, for crushing a first type of coarse material, and the second crushing setting could be a second type of primary crushing setting, for crushing a second type of coarse material, being different from the first type of coarse material.

1. A horizontal shaft impact crusher feed chute for receiving material to be crushed and forwarding the material to a crushing chamber (10) of a horizontal shaft impact crusher, in the horizontal shaft impact crusher feed chute comprising:
a first opening arranged for receiving material to be crushed in a first crushing setting; and
a second opening arranged for receiving material to be crushed in a second crushing setting.

2. A feed chute according to claim 1, further comprising a first cover mounting device for mounting a first cover over the first opening in the second crushing setting.

3. A feed chute according to claim 2, further comprising a second cover mounting device for mounting a second cover over the second opening in the first crushing setting.

4. A feed chute according to claim 1, wherein the second opening is an essentially horizontal opening, and the first opening is an essentially vertical opening.

5. A feed chute according to claim 1, wherein the feed chute comprises includes parallel side walls connecting the first opening to a crusher mounting device arranged for mounting the feed chute to a housing of a horizontal shaft impact crusher, the side walls having an essentially triangular shape as seen from the side thereof.

6. A feed chute according to claim 1, wherein the first opening is separated from the second opening.

7. A feed chute to claim 1, further comprising at least one crushing chamber shield arranged to prevent material from being thrown out of the crushing chamber and out of the feed chute.

8. A feed chute according to claim 7, wherein the crushing chamber shield is arranged to be located in a first position on the feed chute in the first crushing setting, and in a second position on the feed chute in the second crushing setting.

9. A feed chute according to claim 1, further comprising a floor portion arranged for collecting a bed of material protecting the lower portions of the feed chute from wear.

10. A feed chute according to claim 1, further comprising at least one hatch arranged to at least partly cover the first opening in a first mounting position, and to at least partly cover the second opening in a second mounting position.

11. A method of feeding material to be crushed to a horizontal shaft impact crusher, the method comprising;
feeding, when the crusher operates in a first crushing setting, the material through a first opening of a horizontal shaft impact crusher feed chute and further into a crushing chamber of the horizontal shaft impact crusher for being crushed; and
feeding, when the crusher operates in a second crushing setting, the material through a second opening of the horizontal shaft impact crusher feed chute and further into the crushing chamber of the horizontal shaft impact crusher for being crushed.

12. A method according to claim 11, further comprising forwarding the material in an essentially vertical direction into the second opening of the feed chute when the crusher operates in the second crushing setting.

13. A method according to claim 11, further comprising forwarding the material in an at least partly horizontal direction into the first opening of the feed chute when the crusher operates in the first crushing setting.

14. A method according to claim 11, further comprising reducing the opportunities for material to leave the crushing chamber via the first opening of the feed chute when the crusher operates in the second crushing setting, and/or reducing the opportunities for material to leave the crushing chamber via the second opening of the feed chute when the crusher operates in the first crushing setting.

15. A method according to claim 11, further comprising reducing the opportunities for material to rebound out of the crushing chamber via the first opening of the feed chute when the crusher operates in the first crushing setting, and/or reducing the opportunities for material to rebound out of the crushing chamber via the second opening of the feed chute when the crusher operates in the second crushing setting.

16. A horizontal shaft impact crusher comprising:
an impeller;
at least one curtain for crushing material comprising; and
a horizontal shaft impact crusher feed chute, the crusher feed chute including a first opening arranged for receiving the material to be crushed in a first crushing setting and a second opening arranged for receiving the material to be crushed in a second crushing setting.
